(19) United States
(12) Patent Application Publication
(10) Pub. No.: US 2008/0055337 A1
(43) Pub. Date: Mar. 6, 2008

(54) APPARATUS AND METHOD FOR MANAGING CONTENTS USING METADATA IN PORTABLE TERMINAL

(75) Inventor: Yong-Ju YU, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/849,816

(22) Filed: Sep. 4, 2007

(30) Foreign Application Priority Data
Sep. 4, 2006 (KR) 2006-0084608

(51) Int. Cl. G09G 5/00

(52) U.S. Cl. 345/619

(57) ABSTRACT

Provided is an apparatus and method for managing contents in a portable terminal. In the method, selection of a metadata setting menu during display of contents is detected, a list of image-based metasymbols is displayed, and one or more metasymbols of the metasymbol list are mapped to the contents.

### PRIORITY

This application claims priority under 35 U.S.C. §119 to an application filed in the Korean Intellectual Property Office on Sep. 4, 2006, entitled “Apparatus and method for Managing Contents Using Metadata in Portable Terminal” and allocated Serial No. 2006-84608, the contents of which are incorporated herein by reference.

### BACKGROUND OF THE INVENTION

1. Field of the Invention

The present invention relates generally to an apparatus and method for managing contents using metadata in a portable terminal, and more particularly, to an apparatus and method for setting and managing metadata of contents using image-based metasymbols in a portable terminal.

2. Description of the Related Art

Metadata is superordinate data that is associated with contents according to a predetermined rule in order to efficiently search and use desired data out of a large amount of data. In general, metadata is based on text format and is used to represent data and to facilitate a data search.

As an essential concept for Web 2.0, a user-centered Web service that has recently emerged, metadata is attracting great attention. Particularly, in order to provide a user-centered data classification/search method, introduction of the metadata concept in systems capable of storing contents, such as personal computers (PCs) and portable terminals is being considered.

Portable terminals have rapidly spread and become indispensable articles for modem living. The portable terminals provide a variety of additional functions such as portable Internet, digital camera and digital camcorder. In addition, because of their high performance and capacity, the portable terminals can provide environments for generating and storing a variety of contents. However, for management of contents stored in the portable terminals, users rely on a predetermined menu structure. For example, moving picture type contents are accessed in a moving picture management mode and picture image type contents are accessed in a photo album mode. That is, if correlated contents are different in type, they must be accessed in different modes. What is therefore required is the introduction of the metadata concept in order to provide a user-centered contents management/access method.

As described above, when the conventional text-based metadata is used to access contents in portable terminals, users must input a large amount of text data to access the contents. In this case, the users are inconvenienced by the limited input devices of the portable terminals. In addition, the use of the text-based metadata reduces the readability of contents in the limited output devices of the portable terminals. Moreover, because text is a language-dependent means, it impedes the use of metadata for exchanging contents between environments with different languages.

### SUMMARY OF THE INVENTION

An object of the present invention is to solve at least the above problems and/or disadvantages and to provide at least the advantages below. Accordingly, an object of the present invention is to provide an apparatus and method for setting contents metadata in a portable terminal.

Another object of the present invention is to provide an apparatus and method for setting contents metadata through a simplified input in a portable terminal.

Still another object of the present invention is to provide an apparatus and method for constructing a user-centered content relational structure using image-based metasymbols in a portable terminal.

According to one aspect of the present invention, a method for setting contents metadata in a portable terminal includes: detecting selection of a metadata setting menu during display of contents; displaying a list of image-based metasymbols; and mapping one or more metasymbols of the metasymbol list to the contents.

According to another aspect of the present invention, a method for searching contents in a portable terminal includes determining if a content search mode is selected; displaying a list of metasymbols; searching contents subordinate to the metasymbol selected from the metasymbol list; and displaying a list of the searched contents.

According to still another aspect of the present invention, a portable terminal for setting metadata of contents includes a storage unit for storing mapping data of contents and metasymbols; a controller for detecting selection of one or more metasymbols for contents; and a metasymbol mapping unit for mapping the metasymbols to the contents.

According to even another aspect of the present invention, a portable terminal for searching contents includes: a storage unit for storing mapping data of contents and metasymbols; a controller for detecting selection of one or more metasymbols; and a content searching unit for searching contents mapped to the selected metasymbols by reference to the mapping data.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a flowchart of a procedure for setting contents metadata in the portable terminal according to the present invention;

FIG. 3 is a flowchart of a procedure for searching contents in the portable terminal according to the present invention;

FIGS. 4A to 4C are diagrams illustrating a display screen for setting contents metadata in the portable terminal according to the present invention; and

FIGS. 5A to 5C are diagrams illustrating a display screen for searching contents in the portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for managing stored contents using metasymbols in a portable terminal. The metasymbol is image-based metadata and refers to pregnant data such as symbols, icons, and general images.

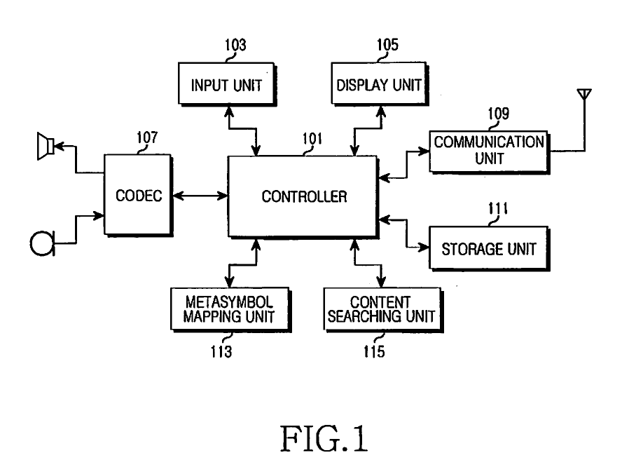

Referring to FIG. 1, the portable terminal includes an antenna, a microphone, a speaker, a controller 101, an input unit 103, a display unit 105, a coder-decoder (CODEC) 107, a communication unit 109, a storage unit 111, a metasymbol mapping unit 113, and a content searching unit 115. Examples of the portable terminal are a cellular phone, a Personal Communication System (PCS) Terminal, a Personal Data Assistant (PDA), and an International Mobile Telecommunications-2000 (IMT-2000) terminal. The following description is made in terms of the general structure of the above terminals.

Controller 101 controls the overall operation of the portable terminal. For example, controller 101 processes and controls functions for voice communication and data communication. In particular, according to the present invention, controller 101 controls a function for providing user-centered content management by using metasymbols. For example, controller 101 controls the function for mapping a metasymbol to a specific content or searching contents by using the metasymbols.

Input unit 103 includes a keypad and provides controller 101 with key input data corresponding to keys pressed by a user. Display unit 105 displays numerals, characters, pictures and status information generated during the operation of the portable terminal.

CODEC 107 converts Pulse Code Modulation (PCM) data received from controller 101 into analog audio signals and outputs the analog audio signals through the speaker. Conversely, CODEC 107 converts analog audio signals received from the microphone into PCM data and provides the PCM data to controller 101. Communication unit 109 processes radio-frequency (RF) signals that are transmitted/received through the antenna.

Storage unit 111 stores: microcodes for the process and control operations of controller 101, a variety of reference data, a variety of updatable data (e.g., contents and metasymbols), and temporary data that are generated during the execution of programs. In particular, according to the present invention, storage unit 111 stores mapping contents data and metasymbols. For example, the mapping data may be stored using table formats illustrated in Tables 1, 2 and 3 below.

TABLE 1

| Field Name | Description |
|---|---|
| Content ID | Content identification |
| Content Name | Content name |
| Content Data | Actual content data or access path |

Table 1 illustrates the format of a content data table. “Content ID” is used to identify contents, “Content Name” is used to indicate the name of content or file input by a user, and “Content Data” is used to indicate actual content data or stored path data.

TABLE 2

| Field Name | Description |
|---|---|
| Metasymbol ID | Metasymbol identification |
| Content ID | Content identification |

Table 2 illustrates the format of a mapping data table. “Metasymbol ID” is used to identify metasymbols and “Content ID” is used to identify contents.

TABLE 3

| Field Name | Description |
|---|---|
| Metasymbol ID | Metasymbol identification |
| Image Data | Access path or image data of an actual metasymbol |
| Base Mean | Brief description provided |
| User Mean | Brief description written by a user |
| Category | Upper metasymbol identification |

Table 3 illustrates the format of a metasymbol data table. “Metasymbol ID” is used to identify metasymbols. “Image Data” is used to indicate stored path data or image data of an actual metasymbol. “Base Mean” is used to indicate a brief description of a metasymbol that is provided together with the metasymbol. “User Mean” is used to indicate a brief description of a metasymbol that is input by a user. The “Base Mean” is a field that is used for a metasymbol provided from a service provider or a manufacturer. Therefore, the “Base Mean” may not be used in case of a metasymbol that is generated by a user using a specific image. The “Category” is used to indicate an upper metasymbol of the metasymbol. That is, the metasymbol may represent other metal symbols as well as contents. Therefore, when a metasymbol is subordinate to another metasymbol, the “Category” is a field that is used to indicate an ID of an upper metasymbol. The “Category” may contain a plurality of IDs.

Metasymbol mapping unit 113 maps a metasymbol to a specific content under the control of controller 101. That is, when a selection of one or more metasymbols for specific contents is detected by controller 101, metasymbol mapping unit 113 records mapping data between the metasymbols and the specific contents in storage unit 111. For example, a table formatted as illustrated in Table 2 is used to record the mapping data.

Content searching unit 115 searches a content using the metasymbol. For example, content searching unit 115 searches contents that are subordinate to one or more metasymbols selected from the metasymbol list. When a plurality of metasymbols are selected, the search operation may be performed using search terms such as “AND” and “OR”.

In the above-described configuration, controller 101 may perform the functions of metasymbol mapping unit 113 and content searching unit 115. Although separate units are provided for the respective functions of controller 101, controller 101 may be designed to perform all or some of the functions instead of such separate units.

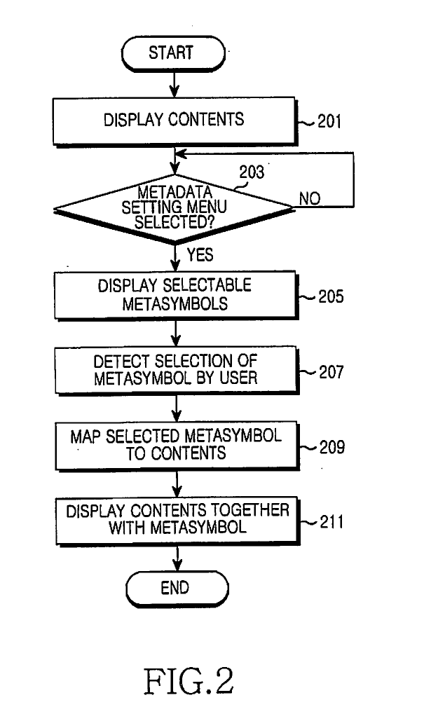

Referring to FIG. 2, controller 101 displays contents in step 201.

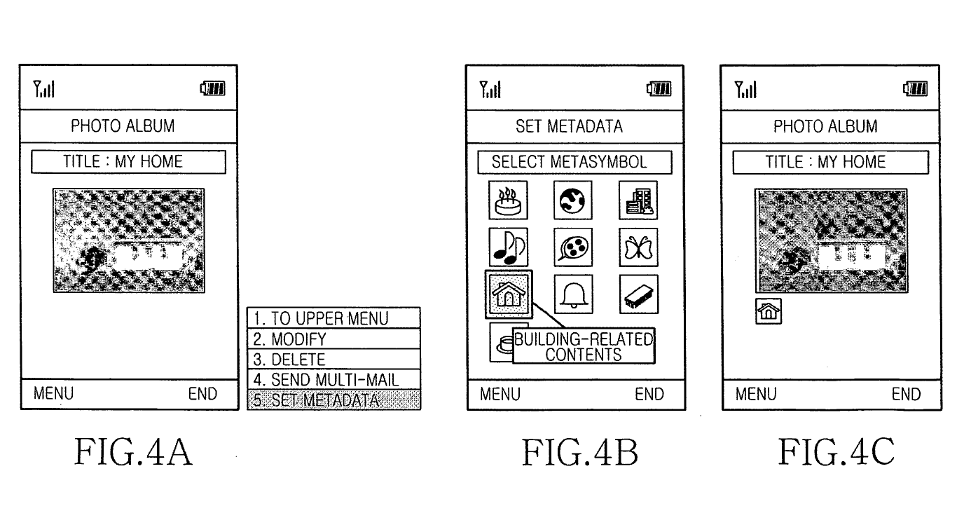

In step 203, controller 101 determines if a metadata setting menu is selected during the display of contents. For example, as illustrated in FIG. 4A, a menu is displayed to determine if the metadata setting menu is selected. If so, the procedure advances to step 205; and if not, step 203 is repeated.

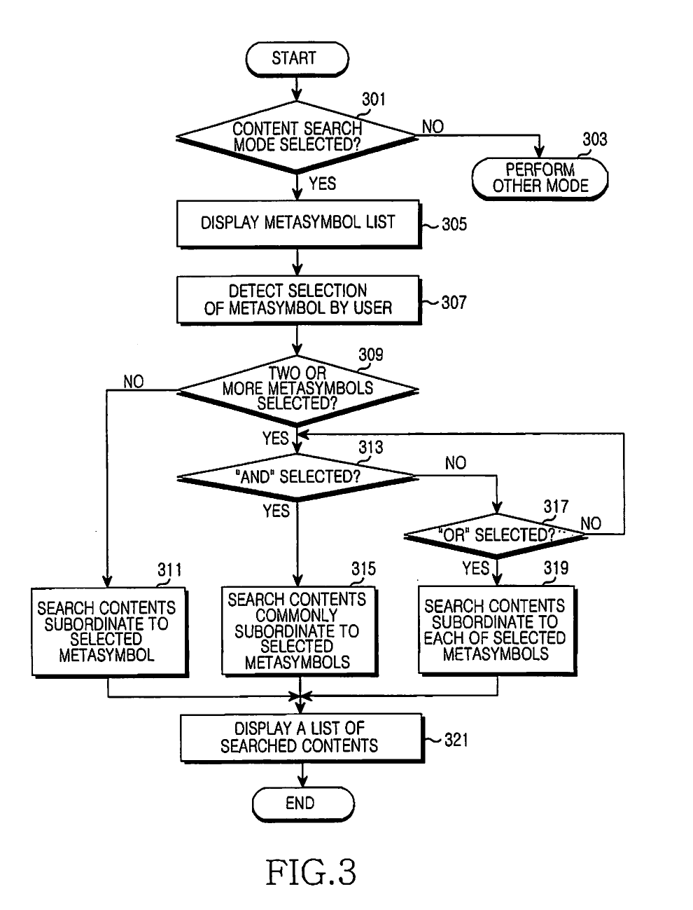

In step 205, controller 101 displays a list of available metasymbols. When a cursor is positioned at a specific metasymbol during the display of the list, controller 101 displays a brief description that is recorded in the “Base Mean” field or the “User Mean” field of the metasymbol data table illustrated in Table 3. At this point, one or both of the brief descriptions recorded in the “Base Mean” field and the “User Mean” field may be displayed according to settings. For example, as illustrated in FIG. 4B, controller 101 displays a list of metasymbols and a brief description of a metasymbol at which the cursor is positioned. In addition, the contents may be pre-mapped to the specific metasymbol. Therefore, during the display of the metasymbol list, the pre-mapped metasymbol may not be displayed or may be displayed in an inactive mode. At this point, only upper metasymbol may be displayed using the “Category” field of the metasymbol data table illustrated in FIG. 3. That is, when one of upper metasymbols is selected by the user, a lower metasymbol of the selected metasymbol is displayed again.

In step 207, controller 101 detects the selection of one or more metasymbols by the user.

In step 209, controller 101 maps the selected metasymbol to the contents. For example, an inter-relationship between the metasymbol and the contents is recorded in a table formatted as illustrated in Table 2. That is, the link between the metasymbol and the contents are formed by the user, thereby making it possible to provide a user-centered content access method.

In step 211, controller 101 displays also the corresponding metasymbol together with the contents. For example, as illustrated in FIG. 4C, a free space of the display screen is used to display the corresponding metasymbol together with the contents. Thereafter, controller 101 ends the procedure.

Referring to FIG. 3, controller 101 determines in step 301 if a content search mode is selected. If so, the procedure advances to step 305; and if not, the procedure advances to step 303.

In step 303, controller 101 performs other modes such as an idle mode.

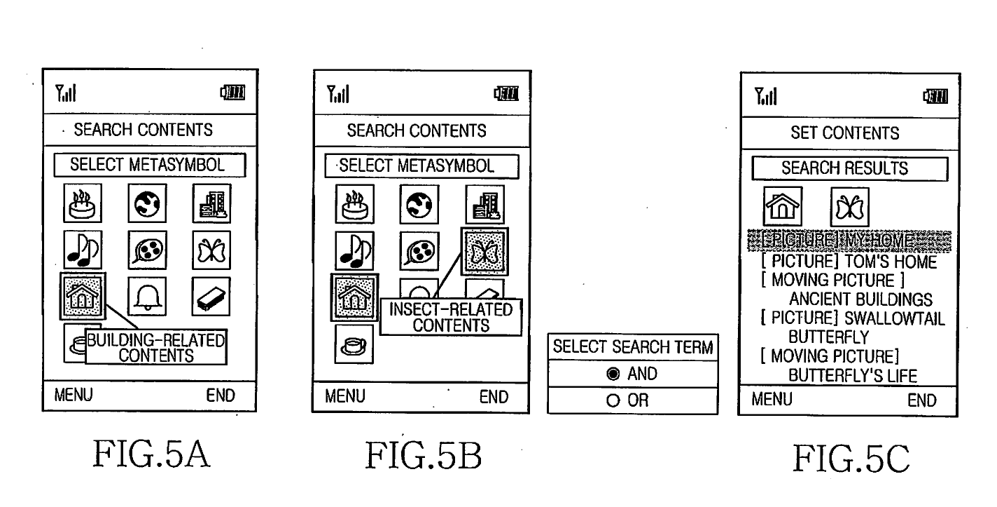

In step 305, controller 101 displays a list of metasymbols. For example, a list of available metasymbols is displayed as illustrated in FIG. 5A. At this point, only metasymbols with subordinate contents may be displayed, while metasymbols without subordinate contents may be displayed in an inactive mode. The metasymbols with subordinate contents may be displayed in order or priority or in different sizes according to the number of the corresponding subordinate contents.

In step 307, controller 101 detects the selection of one or more metasymbols by the user.

In step 309, controller 101 determines if two or more metasymbols have been selected. If so, the procedure advances to step 313; and if not (i.e., if only one metasymbol has been selected), the procedure advances to step 311.

In step 311, controller 101 searches contents that are subordinate to the selected metasymbol.

In step 313, controller 101 determines if “AND” is selected as a search term. For example, as illustrated in FIG. 5B, a pop-up window for selecting a search term is displayed to detect the user's selection. If “AND” is selected, the procedure advances to step 315; and if not, the procedure advances to step 317.

In step 315, controller 101 searches contents that are commonly subordinate to the selected metasymbols.

In step 317, controller 101 determines if “OR” is selected as a search term. For example, as illustrated in FIG. 5B, a pop-up window for selecting a search term is displayed to detect the user's selection. If “OR” is selected, the procedure proceeds to step 319; and if not, the procedure returns to step 313.

In step 319, controller 101 searches contents that are subordinate to each of the selected metasymbols.

After the content search operation, controller 101 displays a list of the searched contents in step 321. For example, a list of the searched contents is displayed as illustrated in FIG. 5C.

Thereafter, controller 101 ends the procedure.

In the above-described embodiment, one or more metasymbols are selected from the metasymbol list for the content search operation. As another embodiment of the present invention, the content search operation may be performed using the “Category” field of the metasymbol data table illustrated in Table 3. That is, the relational structure of the metasymbols may be displayed in a directory structure so that the user can search desired contents proceeding from superordinate concept to subordinate concept.

As described above, the present invention classifies and manages contents in the portable terminal, making it possible to provide an active, user-centered content classification/search method. In addition, the present invention uses image metasymbols as indexes, making it possible to provide a content classification/access method that can satisfy most users of various ages and nationalities.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for setting contents metadata in a portable terminal, the method comprising the steps of:
detecting selection of a metadata setting menu during display of contents;
displaying a list of image-based metasymbols; and
mapping one or more metasymbols of the metasymbol list to the contents.

2. The method of claim 1, wherein the step of displaying the metasymbol list comprises:
detecting a metasymbol pre-mapped to the contents; and
displaying the metasymbol list in such a way that the pre-mapped metasymbol of all available metasymbols is excluded or is displayed in an inactive mode.

3. The method of claim 1, wherein the step of displaying the metasymbol list comprises:
detecting descriptive data of the metasymbols; and
displaying the metasymbol list together with descriptive data of the metasymbol at which a cursor is positioned.

4. The method of claim 1, further comprising displaying the contents together with the metasymbol mapped thereto.

5. A method for searching contents in a portable terminal, the method comprising the steps of:
determining if a content search mode is selected;
displaying a list of metasymbols;
searching contents subordinate to the metasymbol selected from the metasymbol list; and
displaying a list of the searched contents.

6. The method of claim 5, wherein the step of displaying the metasymbol list comprises:
detecting the number of contents subordinate to each metasymbol; and
displaying the metasymbol list in such a way that the metasymbols are displayed in order of priority according to the number of the subordinate contents.

7. The method of claim 5, wherein the step of displaying the metasymbol list comprises:
detecting the number of contents subordinate to each metasymbol; and
displaying the metasymbols of the metasymbol list in different sizes according to the number of the corresponding subordinate contents.

8. The method of claim 5, wherein displaying the metasymbol list comprises:
detecting descriptive data of the metasymbols; and
displaying the metasymbol list together with descriptive data of the metasymbol at which a cursor is positioned.

9. The method of claim 5, wherein displaying the metasymbol list comprises:
detecting a link between the metasymbols; and
displaying the metasymbols in a directory structure according to the link.

10. A portable terminal for setting metadata of contents, the portable terminal comprising:
a storage unit for storing mapping information between contents and metasymbols;
a controller for detecting selection of one or more metasymbols to be mapped to contents; and
a metasymbol mapping unit for mapping the metasymbols to the contents.

11. The portable terminal of claim 10, further comprising a display unit for displaying the contents and the metasymbols,
wherein the controller performs a control operation for displaying a metasymbol list for selection of one or more metasymbols to be mapped to the contents in such a way that the metasymbol pre-mapped to the contents is excluded or is displayed in an inactive mode and a control operation for displaying the contents together with the metasymbol mapped thereto.

12. The portable terminal of claim 10, further comprising a display unit for displaying the contents and the metasymbols,
wherein the controller performs a control operation for displaying a metasymbol list together with a description of the metasymbol.

13. A portable terminal for searching contents, the portable terminal comprising:
a storage unit for storing mapping information between contents and metasymbols;
a controller for detecting selection of one or more metasymbols; and
a content searching unit for searching contents mapped to the selected metasymbols by reference to the mapping information.

14. The portable terminal of claim 13, further comprising a display unit for displaying a list of the metasymbols,
wherein the controller performs a control operation for displaying the metasymbols in order of priority according to the number of contents subordinate to each metasymbol selected for the content search.

15. The portable terminal of claim 13, further comprising a display unit for displaying a list of the metasymbols,
wherein the controller performs a control operation for displaying the metasymbols in different sizes according to the number of contents subordinate to each metasymbol selected for the content search.

16. The portable terminal of claim 13, further comprising a display unit for displaying a list of the metasymbols,
wherein the controller performs a control operation for displaying the metasymbol list together with a description of the metasymbol.

17. The portable terminal of claim 13, further comprising a display unit for displaying a list of the metasymbols,
wherein the controller detects a link between the metasymbols to perform a control operation for displaying the metasymbol list in such a way that the metasymbols are displayed in a directory structure according to the detected connectional relationship.

18. A mobile communication terminal for setting contents metadata in a portable terminal, comprising:
means for detecting selection of a metadata setting menu during display of contents;
means for displaying a list of image-based metasymbols; and
means for mapping one or more metasymbols of the metasymbol list to the contents.
